(19) United States
(12) Patent Application Publication
(10) Pub. No.: US 2026/0345409 A1
(43) Pub. Date: Nov. 5, 2026

(54) VACUUM BAG WITH INTEGRAL CUSTOMIZABLE HEAD POSITIONER

(71) Applicant: MEDTEC LLC, Orange City, IA (US)

(72) Inventors: James Huttner, Sylvania, OH (US); Cody Harder, Perrysburg, OH (US); Susan Brangham, Temperance, MI (US)

(21) Appl. No.: 19/740,831

(22) Filed: Jul. 14, 2026

Related U.S. Application Data
(63) Continuation of application No. 19/080,249, filed on Mar. 14, 2025, now Pat. No. 12,746,160.
(60) Provisional application No. 63/565,552, filed on Mar. 15, 2024.

(51) Int. Cl. A61G 7/057; A47C 27/08; A61G 13/12

(52) U.S. Cl. CPC A61G 7/05753; A47C 27/086; A61G 7/05738; A61G 13/121; A61G 2203/70

(57) ABSTRACT

A cushion to be used for a patient procedure includes a gas-impermeable outer cover configured to form an airtight chamber within the cushion and a control valve configured to provide fluid communication between the airtight chamber and a source of negative pressure. The airtight chamber contains filler beads. The cushion also includes a bag located within the airtight chamber, wherein the bag include at least one gas-permeable portion and second filler beads. The bag may be used as a patient headrest.

### CROSS REFERENCE TO RELATED APPLICATION

This patent application is a continuation of U.S. Patent Application No. 19/080,249 entitled “VACUUM BAG WITH INTEGRAL CUSTOMIZABLE HEAD POSITIONER” and filed on Mar. 14, 2025, which claims priority under 35 U.S.C. § 119 based on U.S. Provisional Application No. 63/565,552 filed Mar. 15, 2024, the disclosures of both which are hereby incorporated by reference herein in their entireties.

### BACKGROUND OF THE INVENTION

Supine positioning is commonly used for patients undergoing a course of radiation therapy for breast cancer. The patient is placed in a semi-recumbent position with the torso elevated at some angle (generally 30 to 40 degrees) by the use of a wing-board.

The wing-board features side panels that help support the patient’s shoulders, and often also includes a T-bar hand grip to help provide support for keeping the arms elevated away from the chest. The wing-board usually also features some sort of headrest support, either in the form of a Moldcare^{tm} custom foam headrest, commercially available from Alcare Co., Ltd. of Tokyo, Japan. a Timo cushion, or a Silverman thermoform.

It is also often desirable to use some sort of vacuum bag patient positioning device overlaying the wing-board (and headrest). When evacuated, the vacuum bag conforms to patient anatomy providing comfort, enhanced support, and superior accuracy in re-positioning the patient for subsequent treatment sessions.

The final positioning assembly thus includes a wing-board (with or without hand grip), headrest of some sort, and vacuum bag patient positioner. This is a cumbersome assembly with several potential problems. First, the assembly includes multiple parts, all of which must be carefully maintained and stored to ensure proper re-positioning of the patient for each treatment session. Second, there is the possibility of headrest “stack-up”, where multiple pieces— e.g., Silverman + Moldcare^{tm} + vacuum bag—lead to the possibility of slippage and loss of treatment accuracy. Lastly, the need to use multiple components is time-consuming, labor-consuming, and expensive, as customizable components such as the Moldcare^{tm} headrest are costly.

### SUMMARY OF THE INVENTION

The invention is a vacuum cushion for positioning a patient for a procedure includes a gas-impermeable outer covering within which an airtight chamber is defined, a source of negative pressure, and a vacuum control valve providing selective fluid communication between the chamber and the source of negative pressure. A first plurality of filler beads is contained within the chamber in selective fluid communication with the source of negative pressure. A separate gas-permeable bag is provided within the airtight chamber defined by the gas-impermeable outer covering, the separate gas-permeable bag contains a second plurality of filler beads. The first plurality of filler beads is contained within the gas-impermeable outer covering but are kept outside of the gas-permeable bag. The gas-permeable bag sized, configured, and positioned so as to be useable as a customizable patient headrest.

In another aspect of the invention, a method of positioning a patient for a medical procedure is provided. The method includes providing a vacuum patient positioning cushion comprising a gas-impermeable outer covering defining an airtight chamber; a vacuum control valve providing selective fluid communication between the chamber and a source of negative pressure; a first plurality of filler beads provided within the chamber; and a separate gas-permeable bag having a second plurality of filler beads contained therein and being in fluid communication with the rest of the airtight chamber. The patient is placed atop the vacuum cushion such that the patient’s head is resting atop the gas-permeable bag, the vacuum control valve is connected to the source of negative pressure, and the vacuum cushion is evacuated while forming the second plurality of filler beads within the gas-permeable bag to act as a headrest for the patient. The remainder of the vacuum cushion is evacuated while forming the first plurality of filler beads to conform to a portion of the patient’s anatomy.

### BRIEF DESCRIPTION OF THE DRAWINGS

The advantages of the invention will become readily apparent to those skilled in the art from the following detailed description of various embodiments when considered in the light of the accompanying drawings, in which:

FIG. 1 shows a planar, schematic view of a preferred embodiment of the vacuum patient positioning cushion of the invention;

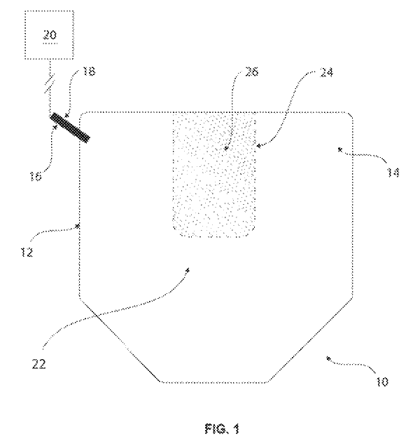

FIG. 2 shows an isometric view of the vacuum patient positioning cushion of FIG. 1; and

FIG. 3 shows a cross-sectional view of the vacuum patient positioning cushion taken along the line 3-3 of FIG. 2.

### DETAILED DESCRIPTION OF THE INVENTION

It is to be understood that the specific devices and processes illustrated in the drawings and described in the following description are simply exemplary embodiments of the inventive concepts defined in the appended claims. Hence, specific dimensions and other physical characteristics relating to the embodiments disclosed herein should not be considered as limiting, unless the claims expressly state otherwise.

Referring to the figures, the vacuum patient positioning cushion 10 of a preferred embodiment of the invention is illustrated. The patient positioning cushion 10 is shown as having a generally “home-plate” shape to conform to a standard radiation therapy wing-board. However, it is understood by those versed in the art that different contours may be used without detracting from the intent of the invention. The patient positioning cushion 10 is formed with a gas-impermeable outer covering 12 that defines an airtight chamber 14.

A valve stem 16 having a selectively closeable valve 18 is secured to the patient positioning cushion 10, extending through the outer covering 12 to provide selective fluid communication to the airtight chamber defined by the outer covering 12. The valve stem 16 is connected to a source of negative pressure 20, such as a vacuum pump, and used to selectively provide fluid communication between the source of negative pressure 20 and the airtight chamber 14, allowing for the evacuation of the airtight chamber 14.

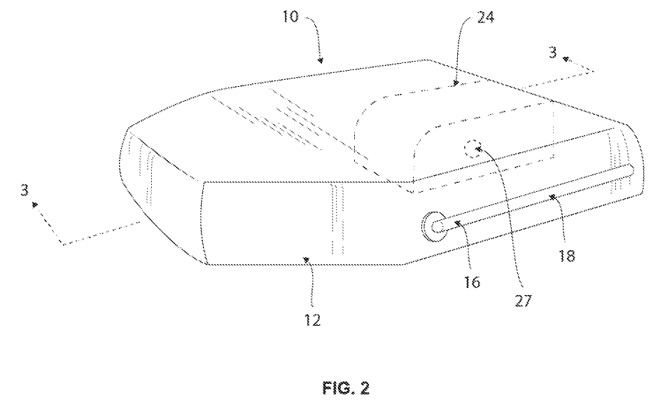

A first plurality of filler beads 22 is provided within the airtight chamber 14. The first plurality of filler beads 22 is preferably formed of a plurality of polymeric beads, most preferably a plurality of expanded polystyrene beads. The filler beads 22 are not shown in FIG. 2 for ease of illustration. The fill rate for the filler beads 22 may vary, depending on the positioning requirements of the particular patient positioning cushion 10.

A separate gas-permeable bag 24 is provided within the airtight chamber 14 defined by the outer covering 12. In the embodiment illustrated in the drawings, the gas-permeable bag 24 is positioned superior-centrally inside the airtight chamber 14 and is sized and configured so as to be useable as a customizable patient headrest. The gas-permeable bag 24 may be made entirely from a material that is permeable to air but will retain the second plurality of filler beads 26 therewithin. Alternatively, the gas-permeable bag 24 may be formed of a gas-impermeable material and provided with at least one gas-permeable portion, such as the mesh screen 27 shown in FIG. 2. The mesh screen 27 provides fluid communication between the airtight chamber 14 and the interior of the gas-permeable bag, while retaining the second plurality of filler beads 26 within the gas-permeable bag 24 and preventing any of the first plurality of filler beads 22 from entering the gas-permeable bag 24.

The gas-permeable bag 24 is thus within and in fluid communication with the airtight chamber 14. A second plurality of filler beads 26 is provided within the gas-permeable bag 24, the filler beads 26 preferably comprising a plurality of polymeric beads, more preferably comprising a plurality of expanded polystyrene beads. The first plurality of filler beads 22 is contained within the gas-impermeable outer covering 12 but are kept outside of the gas-permeable bag 24. The gas-permeable bag 24 prevents the filler beads 26 therewithin from shifting within the airtight chamber 14 of the patient positioning cushion 10. When the airtight chamber 14 is in fluid communication with the source of negative pressure 20 and evacuated, the filler beads 26 within the gas-permeable bag 24 remain in place and are able to conform and mold to the patient’s head anatomy, forming an integral, custom headrest within the patient positioning cushion 10.

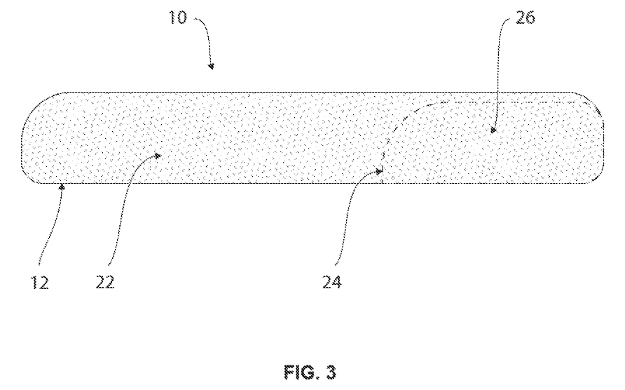

Referring to the cross-sectional view of FIG. 3, the gas-impermeable outer covering 12 of the patient position cushion 10 is shown. The gas-permeable bag 24 is shown positioned towards the central-superior portion of the airtight chamber 14 of the patient positioning cushion 10. Not shown for ease of illustration is the valve stem 16 which is understood in this illustration to be on the opposite side of the patient positioning cushion 10 and thus not visible in this view. It is understood that the placement of the valve stem 16 may vary without detracting from the intent of its use.

The vacuum patient positioning cushion 10 of the invention may be used to position a portion of the body of a patient, preferably the patient’s head. In certain embodiments of the method of the invention, some portion of the body of the patient is placed on the vacuum patient positioning cushion 10 with the being partly or completely in an inflated condition. The gas-permeable bag 24 is positioned such that it supports the desired body part(s), preferably the head, of the patient.

The selectively closeable valve 18 of the valve stem 16 is opened to connect the airtight chamber 14 to the source of negative pressure 20, the airtight chamber 14 being evacuated while the gas-permeable bag 24 is formed to act as a headrest for the patient. The remainder of the airtight chamber 14 is evacuated while forming the filler beads 22 to conform to the patient’s anatomy. The valve may then be closed to prevent fluid communication between the source of negative pressure 20 and the airtight chamber 14 to seal the patient positioning cushion 10 in the proper configuration.

In accordance with the provisions of the patent statutes, the invention has been described in what is considered to represent its preferred embodiments. However, it should be noted that the invention could be practiced otherwise than as specifically illustrated and described without departing from its spirit or scope.

What is claimed is:

1. A cushion to be used for a patient procedure, the cushion comprising:
a gas-impermeable outer cover configured to form an airtight chamber within the
cushion;
a control valve configured to provide fluid communication between the airtight chamber and a source of negative pressure;
a first plurality of filler beads included within the airtight chamber; and
a bag located within the airtight chamber, wherein the bag includes:
at least one gas-permeable portion, and
a second plurality of filler beads,
wherein the bag is positioned to be used as a patient headrest.

2. The cushion of claim 1, wherein the bag is in fluid communication with the airtight chamber.

3. The cushion of claim 1, wherein the at least one gas-permeable portion comprises at least one mesh screen configured to:
provide fluid communication with the airtight chamber, and
wherein the bag is configured to retain the second plurality of filler beads within the bag, and prevent the first plurality of filler beads from entering the bag.

4. The cushion of claim 1, wherein the bag is fixed in position within the airtight chamber.

5. The cushion of claim 4, wherein the bag is affixed to the gas-impermeable outer cover to prevent movement during use.

6. The cushion of claim 1, wherein the first plurality of filler beads comprises a first plurality of polymeric beads and the second plurality of filler beads comprises a second plurality of polymeric beads.

7. The cushion of claim 1, wherein the first plurality of filler beads comprises a plurality of expanded polystyrene beads.

8. The cushion of claim 1, wherein the second plurality of filler beads comprises a plurality of expanded polystyrene beads.

9. The cushion of claim 1, wherein the bag is formed from a gas-permeable material.

10. A method of positioning a patient for a medical procedure, comprising:
providing a patient positioning cushion, the patient positioning cushion comprising:
a gas-impermeable outer covering defining an airtight chamber,
a control valve configured to provide selective fluid communication between
the airtight chamber and a source of negative pressure,
a first plurality of filler beads included within the airtight chamber, and
a bag having at least one gas-permeable portion, and a second plurality of filler
beads, wherein the bag is in fluid communication with the airtight chamber;
connecting the control valve to a source of negative pressure;
evacuating air from the airtight chamber using the source of negative pressure; and
using the bag to act as a headrest for the patient, wherein the first plurality of filler beads are configured to confirm to a portion of the patient’s anatomy.

11. The method of claim 10, wherein the bag is separated from the airtight chamber and the first plurality of filler beads by at least one perforated seam.

12. The method of claim 10, wherein the bag is fixed in position within the airtight chamber.

13. The method of claim 10, wherein the bag is permanently affixed to the outer covering to prevent the bag from shifting location during use.

14. The method of claim 10, wherein the first plurality of filler beads comprises a first plurality of polymeric beads and the second plurality of filler beads comprises a second plurality of polymeric beads.

15. The method of claim 10, wherein the first plurality of filler beads comprises a plurality of expanded polystyrene beads.

16. The method of claim 10, wherein the second plurality of filler beads comprises a plurality of expanded polystyrene beads.

17. The method of claim 10, further comprising:
placing the patient on the patient positioning cushion, wherein the patient’s head is configured to rest on the bag.

18. A system, comprising:
a cushion, wherein the cushion includes:
a gas-impermeable outer cover configured to form an airtight chamber within
the cushion,
a control valve configured to provide fluid communication between the airtight chamber and a source of negative pressure,
a first plurality of filler beads included within the airtight chamber, and
a bag located within the airtight chamber and including a second plurality of filler beads, wherein the bag includes at least one gas-permeable portion and the bag is configured and positioned to be used as a patient headrest.

19. The system of claim 18, further comprising:
the source of negative pressure.

20. The system of claim 18, wherein the bag is formed from a gas-permeable material or the at least one gas permeable portion includes a gas-permeable screen located on a surface of the bag.
